(19) United States
(12) Patent Application Publication
(10) Pub. No.: US 2018/0118519 A1
(43) Pub. Date: May 3, 2018

(54) SERVICE ACCESS ASSEMBLY FOR AN ELEVATOR CAR AND METHOD

(71) Applicants: Nicolas FONTENEAU, Gien (FR); OTIS ELEVATOR COMPANY, FARMINGTON, CT (US)

(72) Inventors: Nicolas Fonteneau, Vitry Aux Loges (FR); Frederic Beauchaud, Coullons (FR); Emmanuel Convard, Gien (FR)

(21) Appl. No.: 15/565,062

(22) PCT Filed: Apr. 10, 2015
(86) PCT No.: PCT/IB2015/000636

§ 371 Date: Oct. 6, 2017

(51) Int. Cl. B66B 11/02; B66B 5/00

(52) U.S. Cl. CPC B66B 11/0246; B66B 19/00; B66B 5/0087; B66B 11/0206

(57) ABSTRACT

A service access assembly for an elevator car includes an elevator car 10 having an interior region 18. Also included is at least one upright structure 26 operatively coupled to the elevator car proximate one of a plurality of side walls 16 of the elevator car, the upright structure extending in a longitudinal direction from the car floor 14 to the car roof 12. Further included is an access opening defined by the upright structure, the access opening accessible to the interior region of the elevator car for service activity by a user located in the interior region. Yet further included is at least one piece of equipment (22, 24) operatively coupled to the upright structure and partially protruding through the access opening.

### BACKGROUND OF THE INVENTION

The embodiments herein generally relate to elevator systems and, more particularly, to a service access assembly for an elevator car of such systems, as well as a method of installing exterior region equipment for an elevator car from an interior region of the elevator car.

Elevators with a shallow pit and/or a low overhead are advantageous because of the reduced impact of their installation on the construction cost and because of the compatibility with severe architectural constraints. However, mechanics are currently tasked with going to the top of the car, or into the pit for inspection or maintenance activities. Requiring individuals to be within the elevator shaft and outside of the elevator car poses complex and/or cumbersome service tasks based on a small area to work within. As such, certain regulatory measures, particularly in Europe, have been proposed and/or enacted that will require larger spaces at the top of the elevator shaft and within the pit. This required additional space is undesirable from a construction and architectural standpoint, as described above.

One approach to combat the above-noted conflicting interests is to avoid the need for mechanics or otherwise authorized personnel to be in the elevator shaft outside of the elevator car. Unfortunately, traditional elevator systems are typically assembled in a manner that still requires assembly, inspection and maintenance activities to be conducted outside of the elevator car.

### BRIEF DESCRIPTION OF THE INVENTION

According to one embodiment, a service access assembly for an elevator car includes an elevator car having an interior region. Also included is at least one upright structure operatively coupled to the elevator car proximate one of a plurality of side walls of the elevator car, the upright structure extending in a longitudinal direction from the car floor to the car roof. Further included is at least one access opening defined by the upright structure, the access opening accessible to the interior region of the elevator car for service activity by a user located in the interior region. Yet further included is at least one piece of equipment operatively coupled to the upright structure and partially protruding through the access opening.

In addition to one or more of the features described above, or as an alternative, further embodiments may include that the piece of equipment comprises a safety ggear member that is engageable with a guide rail.

In addition to one or more of the features described above, or as an alternative, further embodiments may include that the piece of equipment comprises a guiding member that is engageable with a guide rail.

In addition to one or more of the features described above, or as an alternative, further embodiments may include that the piece of equipment comprises a main portion and a back plate portion, wherein the main portion protrudes through the access opening and the back plate portion is operatively coupled to the upright structure.

In addition to one or more of the features described above, or as an alternative, further embodiments may include that the cross-sectional area of the back plate portion is greater than the cross-sectional area of the access opening.

In addition to one or more of the features described above, or as an alternative, further embodiments may include that the back plate portion is completely disposed within the interior region of the elevator car.

In addition to one or more of the features described above, or as an alternative, further embodiments may include that the back plate portion is mechanically fastened to the upright structure with at least one fastener inserted through the back plate portion and the upright structure.

In addition to one or more of the features described above, or as an alternative, further embodiments may include that the back plate portion is operatively coupled to the upright structure in a repeatedly removable manner.

In addition to one or more of the features described above, or as an alternative, further embodiments may include that at least one of the at least one access openings is configured to receive at least one piece of equipment for operative coupling to the upright structure.

In addition to one or more of the features described above, or as an alternative, further embodiments may include that the service activity comprises at least one of installation, inspection, repair and maintenance of the piece of equipment.

According to one embodiment, a method of installing exterior region equipment for an elevator car from an interior region of the elevator car is provided. The method includes aligning at least one piece of equipment with an access opening defined by an upright structure operatively coupled to of the elevator car proximate a side wall of the elevator car, wherein a user performing the alignment of the equipment is located within the interior region of the elevator car. The method also includes translating a portion of the piece of equipment through the access opening to be engageable with a guide rail of a hoistway the elevator car is disposed within. The method further includes operatively coupling the piece of equipment to the upright structure from the interior region of the elevator car.

In addition to one or more of the features described above, or as an alternative, further embodiments may include that the portion of the piece of equipment translated through the access opening comprises a main portion of the piece of equipment and the operative coupling of the piece of equipment to the upright structure comprises mechanically fastening a back plate portion of the piece of equipment to the upright structure.

In addition to one or more of the features described above, or as an alternative, further embodiments may include repeatedly decoupling and coupling the piece of equipment to the upright structure to inspect and maintain the piece of equipment.

In addition to one or more of the features described above, or as an alternative, further embodiments may include that the piece of equipment comprises one of a safety gear member and a guiding member.

### BRIEF DESCRIPTION OF THE DRAWINGS

The subject matter which is regarded as the invention is particularly pointed out and distinctly claimed in the claims at the conclusion of the specification. The foregoing and other features and advantages of the invention are apparent from the following detailed description taken in conjunction with the accompanying drawings in which:

FIG. 1 is a perspective view of an elevator car;

FIG. 2 is a perspective view of a service access assembly of the elevator car in an unassembled condition viewed from an interior region of the elevator car;

FIG. 3 is a perspective view of the service access assembly of the elevator car in the unassembled condition viewed from an exterior region of the elevator car;

FIG. 4 is a perspective view of the service access assembly of the elevator car in an assembled condition viewed from the exterior region of the elevator car; and

FIG. 5 is a perspective view of the service access assembly of the elevator car in the assembled condition viewed from the interior region of the elevator car.

### DETAILED DESCRIPTION OF THE INVENTION

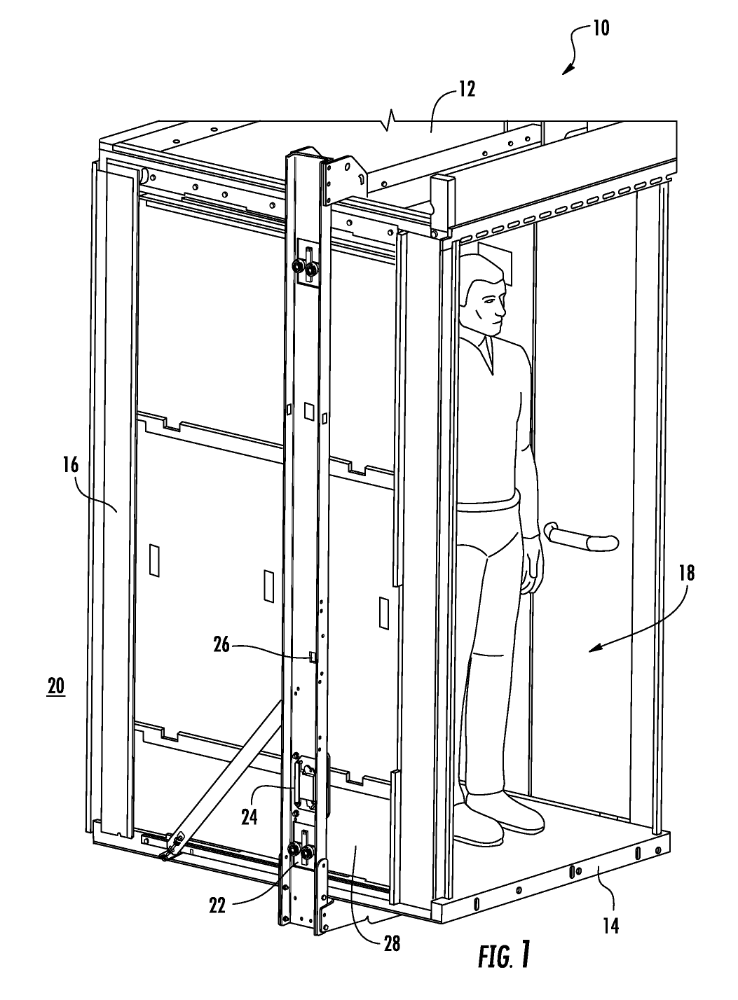

Referring to FIG. 1 an elevator car 10 is illustrated. The elevator car 10 moves along guide rails of an elevator shaft in a known manner. The elevator car 10 is disposed within the elevator shaft and is moveable therein, typically in a vertical manner. The elevator car 10 includes a car roof 12, a car floor 14 and a plurality of side walls 16. Together, the car roof 12, the car floor 14 and the plurality of side walls 16 define an interior region 18 that is dimensioned to carry standing passengers and/or cargo during operation of the elevator car within the overall elevator system.

The region surrounding the elevator car 10, specifically the region surrounding exterior surfaces of the car roof 12, the car floor 14 and the plurality of side walls 16, is referred to herein as an exterior region 20. Generally, the exterior region 20 includes surrounding space within the elevator shaft through which the elevator car 10 travels. Interfaces between the elevator car 10 and equipment required to facilitate desired movement of the elevator car 10 are located within the exterior region 20. For example, a guide rail that is fixedly coupled to a wall of the elevator shaft interacts with one or more guiding members 22 attached to an exterior surface of the elevator car 10 to properly guide, and possibly actuate movement, of the elevator car 10. Additionally, a safety gear member 24 is positioned to engage the guide rail within the exterior region 20 in the event of a safety braking event.

The guiding member(s) 22 and the safety gear member 24 are coupled to an upright structure 26 in some embodiments. The upright structure 26 is a structure that is operatively coupled to the elevator car 10 and is exposed to the exterior region 20. The upright structure 26 is located proximate one of the plurality of side walls 16. The upright structure 26 may be located along an exterior surface 28 of one of the plurality of side walls 16 or aligned with paneling of one of the side walls 16 with an aesthetic backing panel behind the upright inside the elevator car. Alternatively, the upright structure 26 may be aligned with the paneling of one of the side walls 16, but with the back plate portion (described below) hidden by a component inside the elevator car 10, such as a car operating panel. The upright structure 26 extends in a longitudinal direction from the car roof 12 to the car floor 14. Although illustrated as extending along an entire height of the elevator car 10, it is to be appreciated that the upright structure 26 may extend only partially relative to the height of the elevator car 10.

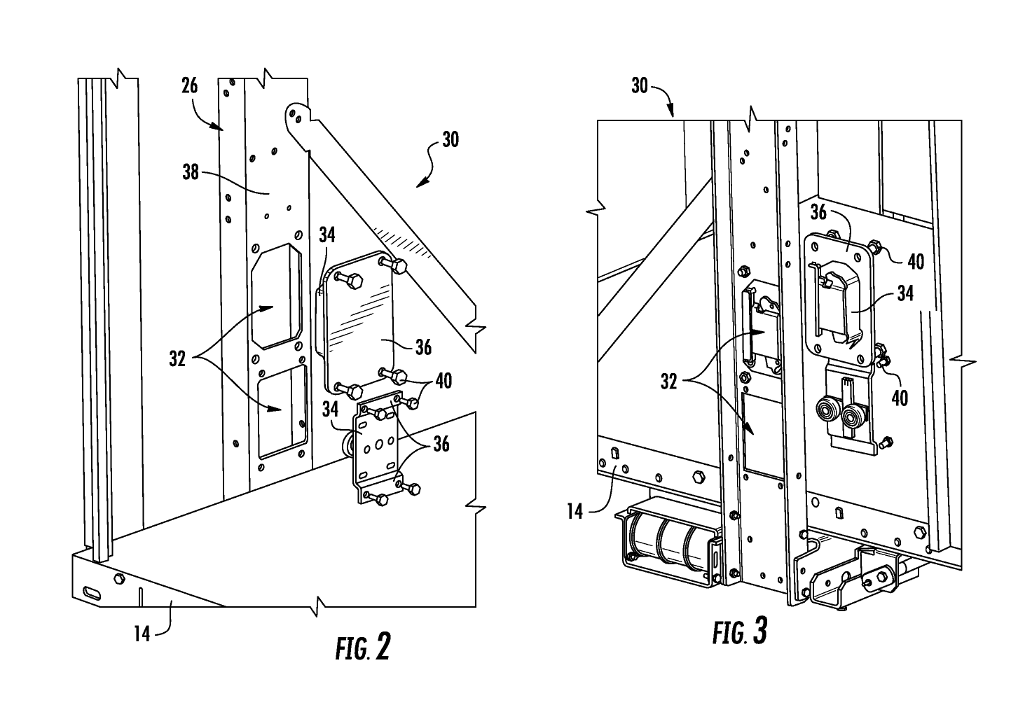

Referring now to FIGS. 2 and 3, a service access assembly 30 for the elevator car 10 is illustrated in an unassembled condition. As will be appreciated from the description herein, the service access assembly 30 is provided to advantageously allow pieces of equipment, such as the guiding member 22 and the safety gear member 24, that require exposure to the exterior region 20 to be fully serviced from the interior region 18 of the elevator car 10. For example, service activities related to the exterior equipment, such as installation, inspection, repair and maintenance may be fully performed by personnel from the interior region 18. Such an assembly eliminates the need for personnel to be situated within the elevator shaft in the exterior region 20 relative to the elevator car 10, thereby avoiding certain hazards associated with such positioning.

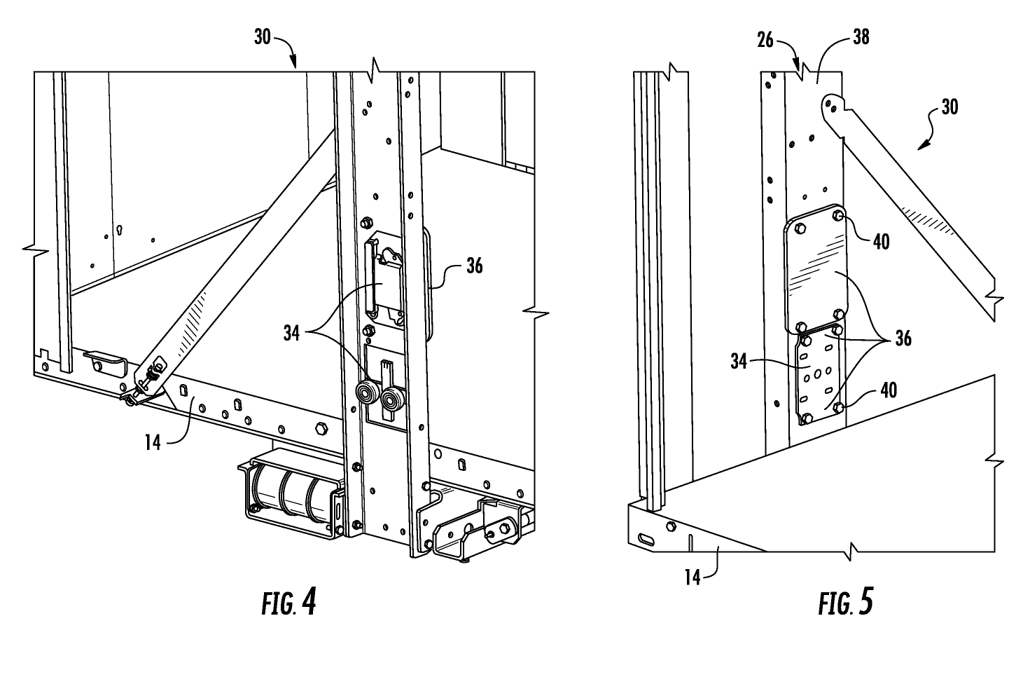

The service access assembly 30 includes one or more access openings 32 defined by the upright structure 26. The access opening(s) 32 is positioned and dimensioned to receive at least one piece of equipment (e.g., guiding member 22, safety gear member 24, etc.) therethrough by insertion in a direction from the interior region 18 of the elevator car 10 toward the exterior region 20. To facilitate mounting of the piece of equipment exposed to the exterior region 20 from the interior region 18 of the elevator car 10, the piece of equipment includes a main portion 34 and a back plate portion 36. The main portion 34 includes the structure and components that functionally interact with the guide rail or alternative structures disposed in the exterior region 20. The main portion 34 is translated through the access opening 32 to protrude through the access opening 32 in a fully assembled condition (FIGS. 4 and 5).

The back plate portion 36 is sized to function as an interface with the upright structure 26 on an interior surface 38 of the upright structure 26. In particular, in one embodiment, the back plate portion 36 has a cross-sectional area that is greater than the cross-sectional area of the access opening 32. In another embodiment, the back plate portion 36 comprises one or more flanges sized and positioned to extend out of alignment with the access opening 32 to engage the interior surface 38 of the upright structure 26. Irrespective of the precise embodiment of the back plate portion 36, it defines a fully inserted position of the piece of equipment within the access opening 32. In the fully inserted position shown in FIGS. 4 and 5, the back plate portion 36 engages the interior surface 38 of the upright structure 26. This position is configured to allow the main portion 34 of the piece of equipment to protrude into the exterior region 20 to a desired extent. In this manner, the back plate portion 36 remains completely disposed within the interior region 18 of the elevator car 10 to facilitate coupling and uncoupling of the piece of equipment by a user in the interior region 18 of the elevator car 10.

The back plate portion 36, and therefore the entire piece of equipment, is operatively coupled to the upright structure 26. In some embodiments, coupling is made with at least one, but typically a plurality of mechanical fasteners 40 that are inserted through apertures defined by the back plate portion 36 and corresponding apertures defined by the upright structure 26. With the use of mechanical fasteners, the piece of equipment is mounted to the upright structure 26 in a repeatedly removable manner to allow for efficient and convenient continued service of the equipment subsequent to initial installation. As described above, this includes service activities such as inspection, maintenance and replacement.

Advantageously, the service access assembly 30 provides field friendly access to various pieces of equipment that is required to be exposed to the exterior region 20 of the elevator car 10. By providing an assembly that facilitates complete installation, inspection, repair maintenance and replacement of such equipment from the interior region 18 of the elevator car 10, various issues associated with service activities being performed by a user in the exterior region 20 are overcome. In particular, a user no longer needs to be located on top of or below the elevator car 10 to carry out the service activities described herein. This assembly and method allows regions of an associated elevator shaft to be reduced in volume, which is desirable for architectural considerations, while complying with proposed and/or enacted standards.

While the invention has been described in detail in connection with only a limited number of embodiments, it should be readily understood that the invention is not limited to such disclosed embodiments. Rather, the invention can be modified to incorporate any number of variations, alterations, substitutions or equivalent arrangements not heretofore described, but which are commensurate with the spirit and scope of the invention. Additionally, while various embodiments of the invention have been described, it is to be understood that aspects of the invention may include only some of the described embodiments. Accordingly, the invention is not to be seen as limited by the foregoing description, but is only limited by the scope of the appended claims.

1. A service access assembly for an elevator car comprising:
an elevator car having an interior region;
at least one upright structure operatively coupled to the elevator car proximate one of a plurality of side walls of the elevator car, the upright structure extending in a longitudinal direction from the car floor to the car roof;
at least one access opening defined by the upright structure, the access opening accessible to the interior region of the elevator car for service activity by a user located in the interior region; and
at least one piece of equipment operatively coupled to the upright structure and partially protruding through the access opening.

2. The service access assembly of claim 1, wherein the piece of equipment comprises a safety gear member that is engageable with a guide rail.

3. The service access assembly of claim 1, wherein the piece of equipment comprises a guiding member that is engageable with a guide rail.

4. The service access assembly of claim 1, wherein the piece of equipment comprises a main portion and a back plate portion, wherein the main portion protrudes through the access opening and the back plate portion is operatively coupled to the upright structure.

5. The service access assembly of claim 4, wherein the cross-sectional area of the back plate portion is greater than the cross-sectional area of the access opening.

6. The service access assembly of claim 4, wherein the back plate portion is completely disposed within the interior region of the elevator car.

7. The service access assembly of claim 4, wherein the back plate portion is mechanically fastened to the upright structure with at least one fastener inserted through the back plate portion and the upright structure.

8. The service access assembly of claim 4, wherein the back plate portion is operatively coupled to the upright structure in a repeatedly removable manner.

9. The service access assembly of claim 1, wherein at least one of the at least one access openings is configured to receive at least one piece of equipment for operative coupling to the upright structure.

10. The service access assembly of claim 1, wherein the service activity comprises at least one of installation, inspection, repair and maintenance of the piece of equipment.

11. A method of installing exterior region equipment for an elevator car from an interior region of the elevator car, the method comprising:
aligning at least one piece of equipment with an access opening defined by an upright structure operatively coupled to of the elevator car proximate a side wall of the elevator car, wherein a user performing the alignment of the equipment is located within the interior region of the elevator car;
translating a portion of the piece of equipment through the access opening to be engageable with a guide rail of a hoistway the elevator car is disposed within; and
operatively coupling the piece of equipment to the upright structure from the interior region of the elevator car.

12. The method of claim 11, wherein the portion of the piece of equipment translated through the access opening comprises a main portion of the piece of equipment and the operative coupling of the piece of equipment to the upright structure comprises mechanically fastening a back plate portion of the piece of equipment to the upright structure.

13. The method of claim 11, further comprising repeatedly decoupling and coupling the piece of equipment to the upright structure to inspect and maintain the piece of equipment.

14. The method of claim 11, wherein the piece of equipment comprises one of a safety gear member and a guiding member.
